(19) United States
(12) Patent Application Publication
(10) Pub. No.: US 2011/0047061 A1
(43) Pub. Date: Feb. 24, 2011

(54) Method for detecting abnormal transactions of financial assets and information processing device performing the method

(76) Inventors: Shih-Chin Lee, Taipei City (TW); Hwai-Chung Ho, Taipei City (TW); Hong-Wei Chuang, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/801,843

(22) Filed: Jun. 29, 2010

(30) Foreign Application Priority Data
Aug. 21, 2009 (TW) 098128245

(51) Int. Cl. G06Q 40/00

(52) U.S. Cl. 705/37

(57) ABSTRACT

A method for detecting abnormal transactions of a financial asset and an information processing device performing the method are disclosed. The method is used for detecting whether a plurality of account data have a abnormal transaction, and the method comprises the steps of: receiving historic information, wherein the historic information comprises the account data and each number of trades made on each transaction day of each account within a period; establishing a plurality of information matrixes; choosing two of the plurality of information matrixes for making an inner product operation and acquiring an inner product value; constructing the threshold of the inner product value; determining whether the inner product value is greater than the threshold of the inner product value; and if yes, determining the two corresponding accounts of the information matrixes having the abnormal transaction.

### BACKGROUND OF THE INVENTION

1. Field of the Invention

The present invention relates to a method for detecting abnormal transactions of a financial asset and an information processing device performing the method; more particularly, the present invention relates to a method for detecting abnormal transactions of the financial asset and an information processing device performing the method, which uses statistics to find a relevance of a plurality of accounts.

2. Description of the Related Art

For a long time, it has been easy for informed traders or illegal syndicates to manipulate investors, as the relevant information is not clear and the investors lack sufficient financial knowledge. These informed traders or illegal syndicates employ such methods as hollowing out companies' assets, insider trading, settlement defaults, and pumping up or dumping prices to illegally make gains by improper trading. These abovementioned methods often cause large variations in stock prices, which both infringe on the rights of the investors and are detrimental to the fairness and stability of the stock market.

However, the existing market surveillance and warning standards use uniform quantification information; hence, they suffer from rigidity as being unable to t set each criterion for each characteristic of each stock and are easily avoided by informed people. Furthermore, illegal syndicates often trade through dummy accounts to elude the authority's monitoring.

Illegal syndicates often use numerous irrelevant dummy accounts for distributed transactions, illegally making gains by continually buying low and selling high. This has long been a major problem in market management. In recent years, certain deficiencies in the market transaction system and financial surroundings, defects of the legal system, and difficulties of collecting evidence have exaggerated the problem of dummy accounts and led to many illegal actions, such as hollowing out companies' assets, insider trading, and settlement defaults. Unless the government solves the problem of dummy accounts, the problem will allow further illegal transactions, destroying the rights of the public, impacting the order of the market, destroying the stability of companies, decreasing the confidence of investors, and severely damaging the investment environment.

Therefore, there is a need to provide a method for detecting abnormal transactions of a financial asset and an information processing device performing the method to obviate the aforementioned problems.

### SUMMARY OF THE INVENTION

It is an object of the present invention to provide a method for detecting abnormal transactions of a financial asset and an information processing device performing the method.

First, the present invention provides a method for detecting abnormal transactions of a financial asset, and the method is performed by an information processing device. The method is used for detecting whether a plurality of accounts having abnormal transactions on the financial asset, the method comprising the following steps: receiving historic information, wherein the historic information comprises the account data and each trading time of each transaction day of each account within a period; establishing a plurality of information matrixes, wherein each of the information matrixes is composed correspondingly of the data of each account, and each entry of each of the information matrixes is the number of trades made on each transaction day for each account; choosing two of the plurality of information matrixes to make an inner product operation and acquiring an inner product value; constructing a threshold of the inner product value; determining whether the inner product value is greater than the threshold of the inner product value; and if the inner product value is greater than the threshold of the inner product value, determining the two corresponding accounts of the information matrixes having the abnormal transaction.

The present invention further provides an information processing device performing the method for detecting abnormal transactions of a financial asset, the information processing device comprising: a processor, and a storage device, electrically connected to the processor, the storage device storing a program. The processor is capable of executing the program to perform the method for detecting abnormal transactions of a financial asset.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 illustrates a hardware architecture of a information processing device according to one preferred embodiment of the present invention.

FIG. 2 is a flowchart of the method for detecting abnormal transactions of a financial asset, according to the preferred embodiment of the present invention.

FIG. 3 is a correlation schematic drawing of the historic information of a financial asset according to the preferred embodiment of the present invention.

FIG. 4 is a correlation schematic drawing of the filtered historic information of a financial asset according to the preferred embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

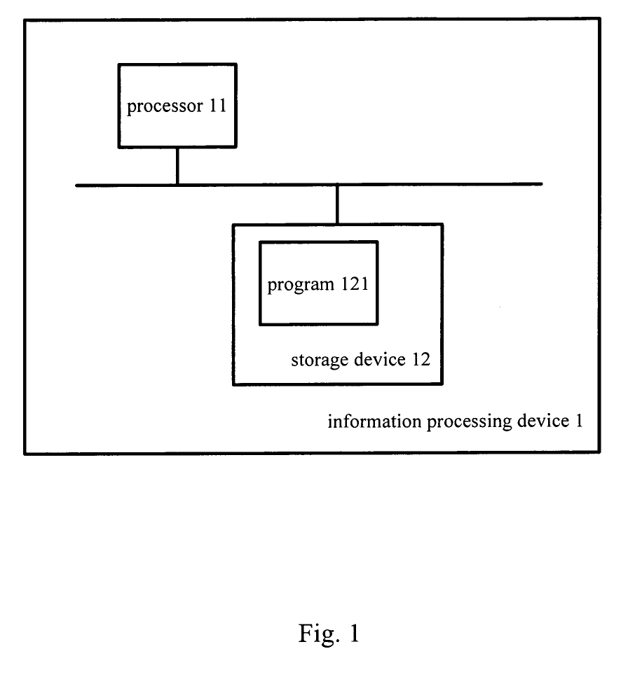

Please refer to FIG. 1, which illustrates a hardware structure of an information processing device according to one embodiment of the present invention.

The information processing device 1 of the present invention is used for detecting whether a plurality of accounts have abnormal transactions on a financial asset. The information processing device 1 comprises a processor 11; a storage device 12, electrically connected to the processor 11, the storage device 12 storing a program 121. In one embodiment of the present invention, the information processing device 1 can be a server, a desktop computer, a notebook computer, a tablet PC, or a personal digital assistant (PDA). However, the present invention is not only limited to these devices.

Generally speaking, illegal syndicates use dummy accounts for distributed transactions to avoid being investigated by competent authorities. There are two major characteristics of the transaction of dummy accounts. The first is that of continuous mass transaction on a specific financial asset with intensive buying low or selling high in order to raise or decrease the price of the specific financial asset in order to gain illegal profits. The second is that of using a plurality of accounts (from several dozen accounts to hundreds of accounts) for distributed transactions to hide the pump-and-dump intention and thus avoid being investigated by competent authorities. The method for detecting abnormal transactions of a financial asset of the present invention is based on the principle of “intensive transaction” and “simultaneous transaction,” and is derived by the development of using statistical methods.

The process of how the information processing device 1 in FIG. 1 of the present invention performs the method for detecting abnormal transactions of a financial asset via the processor 11 executing the program 121 will be described hereinafter. Please note that the method for detecting abnormal transactions of a financial asset of the present invention is not limited to use in the information processing device 1 in FIG. 1.

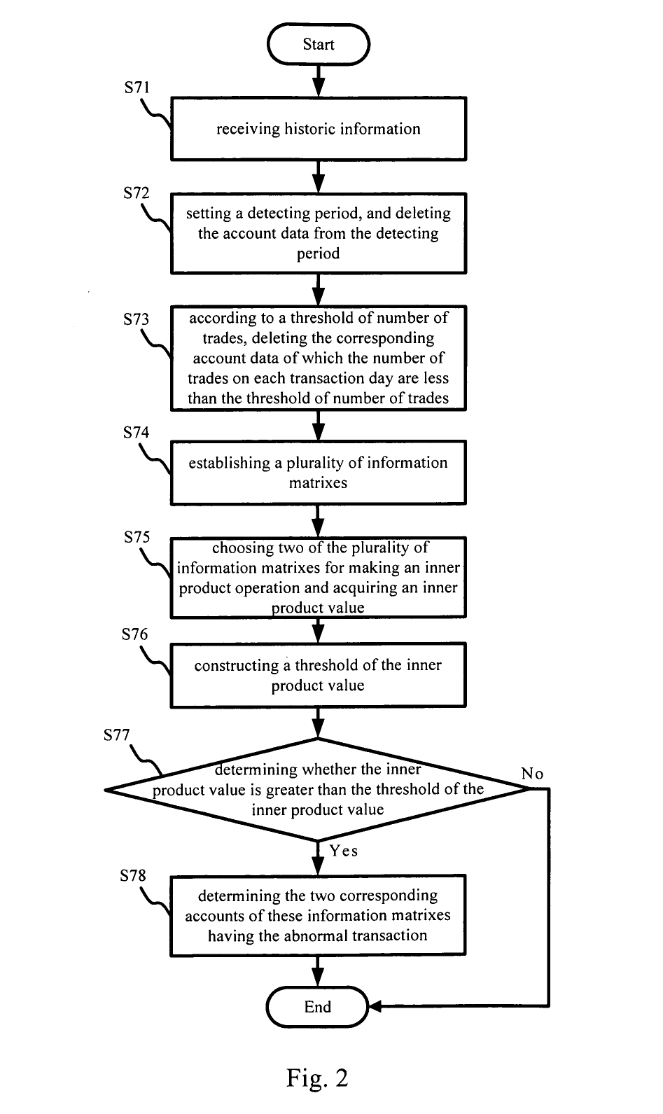

As shown in FIG. 2, the present invention first performs step S71: receiving historic information.

In one embodiment of the present invention, the financial asset is the merchandise for which the investors trade, and comprises listed stocks, OTC stocks, funds, bonds, currencies, futures, etc.

In one embodiment of the present invention, the historic information comprises the account data and the number of trades made on each transaction day of each account. The account data comprise general accounts, and can further comprise the accounts of securities investment trust companies, dealers, and foreign-funded enterprises. Please note that some accounts which have large transaction volumes and trade frequently, such as securities investment trust companies and foreign-funded enterprises, can be excluded in practice.

In one embodiment of the present invention, the number of trades is a sum of successful buying instances and successful selling instances of the financial asset. However, the embodiment of the present invention is not limited to the abovementioned examples.

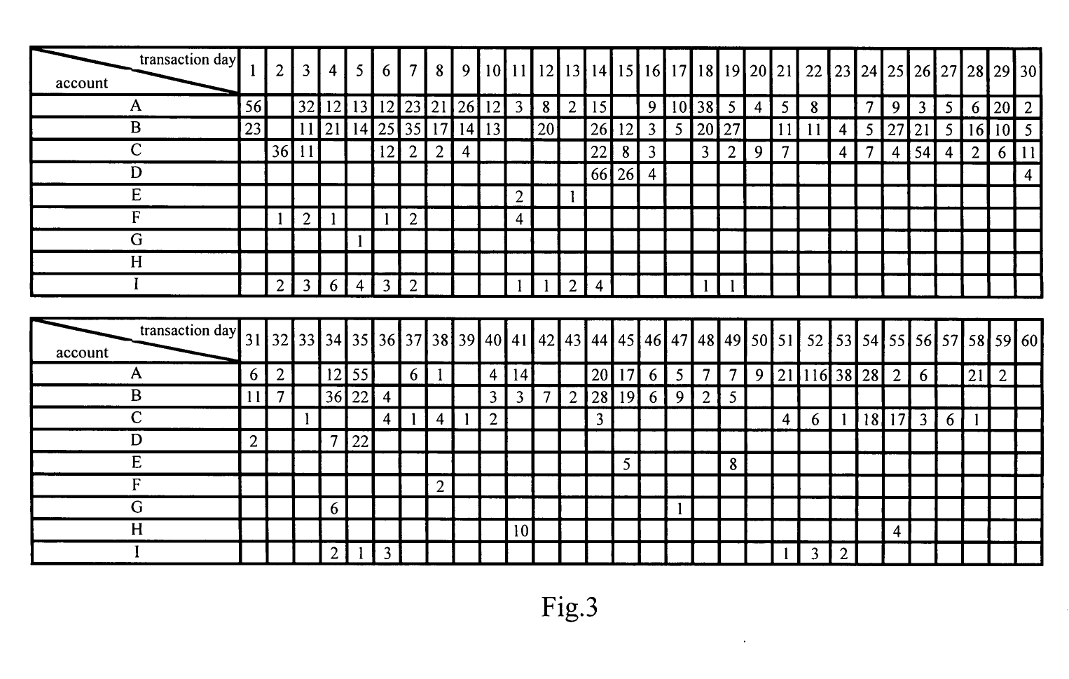

Please refer to FIG. 3, which is a correlation schematic drawing of the historic information of a financial asset according to one embodiment of the present invention. FIG. 3 illustrates each of the number of trades for each account datum of a financial asset in 60 days (i.e. 60 transaction days), wherein the account data comprises 9 accounts, account A to account I, and a blank represents that no transaction occurred on that day. Please note that for the sake of simplifying the description, this embodiment lists only nine accounts and each number of trades for 60 days of each of the nine accounts; however, the scope of the present invention is not limited to the abovementioned description. Please note that account A to account I can be all accounts or suspicious accounts of the financial asset. However, the embodiment of the present invention is not limited to the abovementioned examples.

The present invention next performs step S72: setting a detecting period, and deleting the account data from the detecting period.

In one embodiment of the present invention, the detecting period is 45 days, wherein the detecting period is a time period that the method for detecting abnormal transactions of a financial asset will examine. However, the embodiment of the present invention is not limited to the above-mentioned examples. In another embodiment of the present invention, the detecting period is substantially between 20 days and 90 days.

The present invention next performs step S73: according to a threshold of number of trades, deleting the corresponding account data of which the number of trades on each transaction day are less than the threshold of number of trades.

To reduce computing time and avoid consumption of resources of the information processing device 1, the method for detecting abnormal transactions of a financial asset of the present invention provides setting the threshold of number of trades, and deleting the corresponding account data of which each number of trades on each transaction day is less than the threshold of number of trades, wherein the threshold of number of trades is substantially between 20 and 150. However, please note that the scope of the present invention is not limited to the above description.

In one embodiment of the present invention, the threshold of number of trades is 35, and the method deletes the account data of which each number of trades between the first and the 45th transaction day is less than 35.

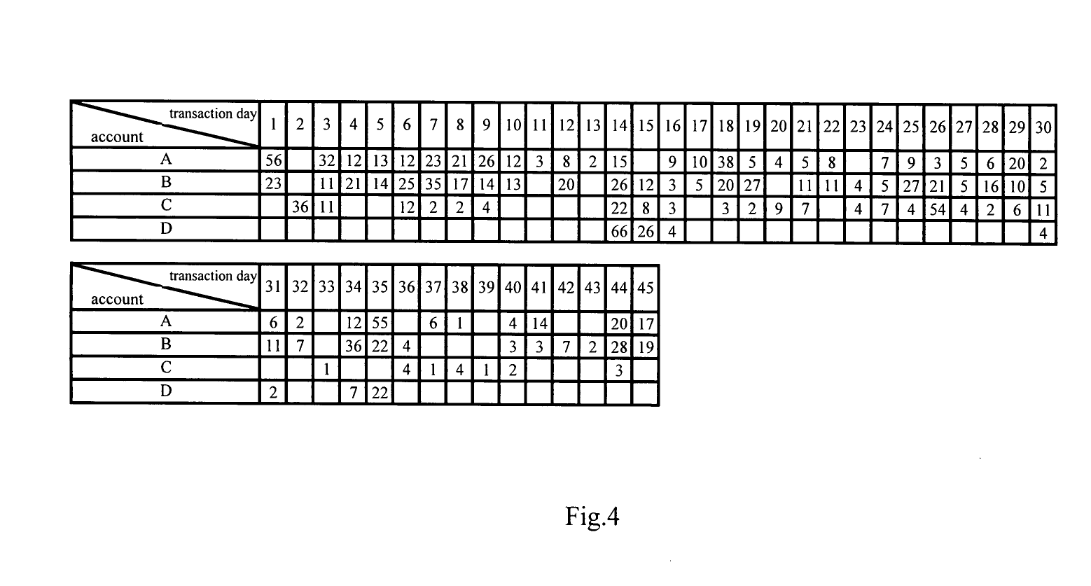

As shown in FIG. 4, in step S73, account E to account I are deleted because each of their number of trades between the first and the 45th transaction days is less than 35.

The present invention next performs step S74: establishing a plurality of information matrixes.

In one embodiment of the present invention, each of the information matrixes is composed correspondingly of each of account data, and each of the matrix elements of each of the information matrixes is the number of trades of each transaction day of each account; therefore, the plurality of information matrixes is converted into an N×W matrix, where N is the amount of the account data, and W is the detecting period. In one embodiment of the present invention, N is 4, and W is 45.

In one embodiment of the present invention, each of these information matrixes respectively is:

account A
[56,0,32,12,13,12,23,21,26,12,3,8,2,15,0,9,10,38,5,4,5,8,0,7,9,3,5,6 6,20,2,6,2,0,12,55,0,6,1,0,4,14,0,0,20,17]
account B
[23,0,11,21,14,25,35,17,14,13,0,20,0,26,12,3,5,20,27,0,11,11,4,5,2 7,21,5,16,10,5,11,7,0,36,22,4,0,0,0,3,3,7,2,28,19]
account C
[0,36,11,0,0,12,2,2,4,0,0,0,0,22,8,3,0,3,2,9,7,0,4,7,4,54,4,2,6,11,0, 0,1,0,0,4,1,4,1,2,0,0,0,3,0]
account D
[0,0,0,0,0,0,0,0,0,0,0,0,0,66,26,4,0,0,0,0,0,0,0,0,0,0,0,0,0,4,2,0, 0,7,22,0,0,0,0,0,0,0,0,0,0]

Therefore, the plurality of information matrixes is converted into a 4×45 matrix.

The present invention next performs step S75: choosing two of the plurality of information matrixes for making an inner product operation and acquiring an inner product value.

The present invention next performs step S76: constructing a threshold of the inner product value.

In one embodiment of the present invention, a formula of the threshold of the inner product value is Z=X²×W, wherein Z is the threshold of the inner product value, X is an average number of number of trades of non-empty matrix elements of the plurality of information matrixes, and W is the detecting period. In one embodiment of the present invention, Z is 8140, where X is 13.45 and W is 45.

In one embodiment of the present invention, each of the information matrixes corresponding to the data of each account can be viewed as a kind of vector, and choosing any two accounts from account A to account D to make an inner product operation allows calculation of an inner product value.

In one embodiment of the present invention, the inner product value of account A and account B is 10012, the inner product value of account A and account C is 1859, the inner product value of account A and account D is 2340, the inner product value of account B and account C is 3015, the inner product value of account B and account D is 2818, and the inner product value of account C and account D is 1716.

The present invention next performs step S77: determining whether the inner product value is greater than the threshold of the inner product value.

If the inner product value is greater than the threshold of the inner product value, the present invention next performs step S78: determining the two corresponding accounts of these information matrixes having the abnormal transaction.

In one embodiment of the present invention, because the inner product value of account A and account B is greater than the threshold of the inner product value, the method of the present invention will determine that account A and account B probably have a abnormal transaction, with intensive transaction and simultaneous transaction within the 45 transaction days.

In one embodiment of the present invention, after determining whether account A to account I have abnormal transactions from the first transaction day to the 45th transaction day, the method of the present invention continues to determine whether account A to account I have abnormal transactions from the second transaction day to the 46th transaction day, and so on.

Please note that these steps mentioned above are not all necessarily performed (like step S72 or step S73), and any person skilled in the art to which it pertains, or with which it is most nearly connected, can vary or combine the order of the steps (alternating step S72 and step S73) as long as it can fulfill the object of the present invention.

The present invention further provides an analyzing strategy for the detecting period and the threshold of number of trades. The analyzing strategy comprises a best strategy, a strictest strategy, and a distributing strategy. In the best strategy, the detecting period is 45, and the threshold of number of trades is 35. In the strictest strategy, the detecting period is 40, and the threshold of number of trades is 100. In the distributing strategy, these financial assets are divided into “high volume financial assets” and “low volume financial assets” according to “trading volume of daily average” and “trading volume of number of trades average”. If a financial asset is under the trading volume of the daily average and the trading volume of number of trades average, it is classified as a high volume financial asset; all others are classified as low volume financial assets.

The detecting period of the high volume financial asset is 40, and the threshold of number of trades of the high volume financial asset is 60; the detecting period of the low volume financial asset is 40, and the threshold of number of trades of the low volume financial asset is 30.

Although the present invention has been explained in relation to its preferred embodiments, it is to be understood that many other possible modifications and variations can be made without departing from the spirit and scope of the invention as hereinafter claimed.

What is claimed is:

1. A method for detecting abnormal transactions of a financial asset, performed by an information processing device, the method used for detecting whether a plurality of accounts having abnormal transactions on the financial asset, the method comprising the steps of:
receiving historic information, wherein the historic information comprises the account data and each number of trades made on each transaction day of each account within a period;
establishing a plurality of information matrixes, wherein each of the information matrixes is composed correspondingly of data of each account, and each entry of each of the information matrixes is the number of trades made on each transaction day of each account;
choosing two of the plurality of information matrixes for making an inner product operation and acquiring an inner product value;
constructing a threshold of the inner product value;
determining whether the inner product value is greater than the threshold of the inner product value; and
if the inner product value is greater than the threshold of the inner product value, determining the two corresponding accounts of the information matrixes having the abnormal transaction.

2. The method for detecting abnormal transactions of a financial asset as claimed in claim 1, further comprising a step after the step of receiving the historic information:
according to a threshold of number of trades, deleting the corresponding account data of which the number of trades made on each transaction day is less than the threshold of number of trades.

3. The method for detecting abnormal transactions of a financial asset as claimed in claim 3, further comprising a step after the step of receiving the historic information:
setting a detecting period, and deleting the account data from the detecting period.

4. The method for detecting abnormal transactions of a financial asset as claimed in claim 3, wherein a formula of the threshold of the inner product value is Z=X²×W, where Z is the threshold of the inner product value, X is the average of the number of trades of non-empty matrix elements of the plurality of information matrixes, and W is the detecting period.

5. The method for detecting abnormal transactions of a financial asset as claimed in claim 4, wherein the plurality of information matrixes is converted into an N×W matrix, where N is an amount of the plurality of information matrixes, and W is the detecting period.

6. The method for detecting abnormal transactions of a financial asset as claimed in claim 5, wherein the threshold of number of trades is substantially between 20 and 150.

7. The method for detecting abnormal transactions of a financial asset as claimed in claim 5, wherein the detecting period is substantially between 20 days and 90 days.

8. The method for detecting abnormal transactions of a financial asset as claimed in claim 1, wherein the number of trades is a sum of successful buying instances and successful selling instances of the financial asset.

9. The method for detecting abnormal transactions of a financial asset as claimed in claim 1, wherein the financial asset is a stock, fund, bond, currency, or future.

10. An information processing device for detecting whether a plurality of accounts having abnormal transactions on a financial asset, the information processing device comprising:
a processor;
a storage device, electrically connected to the processor, and the storage device storing a program; and
the processor is capable of executing the program to perform the steps of:
receiving historic information, wherein the historic information comprises the account data and each number of trades made on each transaction day of each account within a period;
establishing a plurality of information matrixes, wherein each of information matrixes is composed correspondingly of data of each account, and each entry of each of the information matrixes is the number of number of trades made on each transaction day of each account;
choosing two of the plurality of information matrixes for making an inner product operation and acquiring an inner product value;
constructing a threshold of the inner product value;
determining whether the inner product value is greater than the threshold of the inner product value; and
if the inner product value is greater than the threshold of the inner product value, determining the two corresponding accounts of the information matrixes having the abnormal transaction.

11. The information processing device as claimed in claim 10, further comprising a step after the step of receiving the historic information:
according to a threshold of number of trades, deleting the corresponding account data of which each number of trades made on each transaction day is less than the threshold of number of trades.

12. The information processing device as claimed in claim 11, wherein the historic information is within a detecting period.

13. The information processing device as claimed in claim 12, wherein a formula of the threshold of the inner product value is:
Z=X²×W, where Z is the threshold of the inner product value, X is the average of number of trades of non-empty matrix elements of the plurality of information matrixes, and W is the detecting period.

14. The information processing device as claimed in claim 13, wherein the plurality of information matrixes is converted into an N×W matrix, where N is an amount of the plurality of information matrixes, and W is the detecting period.

15. The information processing device as claimed in claim 14, wherein the threshold of number of trades is substantially between 20 and 150.

16. The information processing device as claimed in claim 14, wherein the detecting period is substantially between 20 days and 90 days.

17. The information processing device as claimed in claim 10, wherein the number of trades is a sum of successful buying instances and successful selling instances of the financial asset.

18. The information processing device as claimed in claim 10, wherein the financial asset is a stock, fund, bond, currency, or future.
